(19) United States
(12) Patent Application Publication
(10) Pub. No.: US 2023/0294355 A1
(43) Pub. Date: Sep. 21, 2023

(54) POLYMER RESIN FORMULATIONS FOR USE IN ADDITIVE MANUFACTURING PROCESSES

(71) Applicant: General Electric Company, Schenectady, NY (US)

(72) Inventors: James Robert Tobin, Greenville, SC (US); Andrew McCalip, New Orleans, LA (US); Robenson Cherizol, Mandeville, LA (US); Hongyi Zhou, Schenectady, NY (US)

(21) Appl. No.: 18/011,243

(22) PCT Filed: Jun. 24, 2021
(86) PCT No.: PCT/US2021/038810

§ 371 Date: Dec. 19, 2022

Related U.S. Application Data
(60) Provisional application No. 63/043,184, filed on Jun. 24, 2020.
(60) Provisional application No. 63/043,191, filed on Jun. 24, 2020.
(60) Provisional application No. 63/043,200, filed on Jun. 24, 2020.

(51) Int. Cl. B29C 64/124; B29D 99/00; C08K 5/54; C08G 63/183; C08G 69/02

(52) U.S. Cl. CPC B29C 64/124; B29D 99/0025; C08K 5/54; C08G 63/183; C08G 69/02; B33Y 10/00

(57) ABSTRACT

A system for forming an article includes a polymer resin formulation formed of a semicrystalline polymer material having a first fiber content and an amorphous polymer material having a second fiber content. The first fiber content is higher than the second fiber content. Further, the semicrystalline and amorphous polymer materials are blended together to form the polymer resin formulation having a blended fiber content of greater than 10% by weight. Moreover, the polymer resin formulation is amorphous. The system also includes a computer numeric control (CNC) device for printing and depositing the polymer resin formulation layer by layer to form the article.

### CROSS-REFERENCE TO RELATED APPLICATIONS

This application claims the benefit of U.S. Provisional Patent Application Nos. 63/043,184, 63/043,191, and 63/043,200, all three filed on Jun. 24, 2020, which are incorporated by reference herein in their entirety.

### FIELD

The present disclosure relates in general to additive manufacturing, and more particularly to polymer resin formulations for use in additive manufacturing processes, such as three-dimensional (3-D) printing.

### BACKGROUND

Wind power is considered one of the cleanest, most environmentally friendly energy sources presently available, and wind turbines have gained increased attention in this regard. A modern wind turbine typically includes a tower, a generator, a gearbox, a nacelle, and one or more rotor blades. The rotor blades capture kinetic energy of wind using known foil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

The rotor blades generally include a suction side shell and a pressure side shell typically formed using molding processes that are bonded together at bond lines along the leading and trailing edges of the blade. Further, the pressure and suction shells are relatively lightweight and have structural properties (e.g., stiffness, buckling resistance and strength) which are not configured to withstand the bending moments and other loads exerted on the rotor blade during operation. Thus, to increase the stiffness, buckling resistance and strength of the rotor blade, the body shell is typically reinforced using one or more structural components (e.g., opposing spar caps with a shear web configured therebetween).

The spar caps are typically constructed of various materials, including but not limited to glass fiber laminate composites and/or carbon fiber laminate composites. The shell of the rotor blade is generally built around the spar caps of the blade by stacking layers of fiber fabrics in a shell mold. The layers are then typically infused together with a resin.

As such, the art is continuously seeking new and improved methods for forming rotor blades and components thereof. For example, it may be desirable to manufacture some of the various wind turbine components using additive manufacturing techniques, such as 3-D printing. Although, certain considerations must be taken into account when manufacturing wind turbine components, such as loading, stiffness, strength, etc. For example, high glass fiber resins are required for stiffness and modulus for 3-D printed polymer articles. In addition, semicrystalline resins have a narrow process window due to crystallization, and, as such, the printing process may not be as robust as other materials. Furthermore, semicrystalline thermoplastics, in general, are characterized by a sharp transition from the liquid to solid state around its melting temperature. This sharp transition corresponds to crystallization of at least a portion of the material.

Moreover, conventional 3-D printing systems use extrusion methods for printing thermoplastics with filaments or pellets. With such systems, using amorphous thermoplastics with and without fiber reinforcement may also be used. Amorphous-based thermoplastics are often selected because of a wide processing window for 3-D printing. However, amorphous thermoplastics, in general, may not have physical properties that are desirable for 3-D printing, such as increased stiffness or chemical resistance as compared to semicrystalline thermoplastics. While printing semicrystalline-based thermoplastics by extrusion-based printing methods is known, it often requires the use of enclosed chambers to provide a warmer than room temperature printing environment to promote layer-to-layer bonding during the printing process. Thus, for large, printed articles, such enclosures may be impractical.

In view of the foregoing, the present disclosure is directed to an improved polymer resin formulation for use in additive manufacturing processes, such as 3-D printing. In particular, the polymer resin formulations of the present disclosure enable improved physical, mechanical and/or chemical resistance properties compared with conventional amorphous-based resins. Further, the polymer resin formulations of the present disclosure can be used in 3-D printing without the use of heated enclosures or other means to provide a heated environment. Moreover, the polymer resin formulations of the present disclosure may not require reheating of the printed material to be deposited on, just prior to printing deposition.

### BRIEF DESCRIPTION

Aspects and advantages of the invention will be set forth in part in the following description, or may be obvious from the description, or may be learned through practice of the invention.

In one aspect, the present disclosure is directed to a system for forming an article. The system includes a polymer resin formulation including a semicrystalline thermoplastic material having a first fiber content and an amorphous thermoplastic material having a second fiber content. The first fiber content is greater than or equal to the second fiber content. Further, the semicrystalline and amorphous polymer materials are blended together to form the polymer resin formulation having a blended fiber content of greater than 10% by weight. Moreover, the polymer resin formulation crystallizes slower than the semicrystalline thermoplastic material. The system also includes a computer numeric control (CNC) device for printing and depositing the polymer resin formulation layer by layer to form the article.

In an embodiment, the amorphous polymer material includes a mixture of an amorphous thermoplastic material and a silane coupling agent. In such embodiments, the silane coupling agent has polar functionality.

In further embodiments, a weight percent of the amorphous polymer material is greater than 50% of the polymer resin formulation excluding the first and second fiber contents. In an embodiment, for example, the first fiber content is equal to or greater than 30% and the second fiber content is equal to or less than 30%. In another embodiment, the second fiber content is equal to zero.

In several embodiments, the semicrystalline polymer material may include at least one of polybutylene terephthalate (PBT), poly(ethylene terephthalate) (PET), polytrimethylene terephthalate (PTT), polycyclohexylendimethylene terephthalate (PCT), or polyamide (PA). In another embodiment, the amorphous polymer material comprises at least one of a thermoplastic copolyester, amorphous poly(ethylene terephthalate) (APET), polymethyl methacrylate (PMMA), acrylonitrile butadiene styrene (ABS), polycarbonate (PC), thermoplastic polyurethane (TPU).

In particular embodiments, the amorphous polymer material may be the APET, with the APET containing an amount of polyethylene isophthalate (PEI).

In further embodiments, the amount of PEI in the APET is between about 0.5 mol % to about 50 mol %.

In another aspect, the present disclosure is directed to a method of forming an article. The method includes providing a semicrystalline polymer material having a first fiber content. The method also includes providing an amorphous polymer material having a second fiber content, the first fiber content being greater than or equal to the second fiber content. Further, the method includes blending the semicrystalline and amorphous polymer materials together to form a polymer resin formulation having a blended fiber content of greater than 10% by weight, the polymer resin formulation crystallizing slower than the semicrystalline thermoplastic material. In addition, the method includes printing and depositing, via a computer numeric control (CNC) device, the polymer resin formulation layer by layer to form the article.

In an embodiment, the method includes blending a silane coupling agent with the amorphous polymer material via at least one of dry blending or compounding.

In another method, the method may include providing a mixture of the silane coupling agent and the amorphous polymer material to a first hopper of an extruder of the CNC device and adding the semicrystalline polymer material to the mixture of the silane coupling agent and the amorphous polymer material.

In additional embodiments, the method may include blending the mixture of the silane coupling agent and the amorphous polymer material with the semicrystalline polymer material immediately before printing and depositing the polymer resin formulation layer by layer to form the article.

In several embodiments, the method may include heating the blended semicrystalline and amorphous polymer materials for a first time frame and cooling the blended semicrystalline and amorphous polymer materials to form the polymer resin formulation.

In further embodiments, a weight percent of the amorphous polymer material is greater than 50%. Moreover, in an embodiment, the first fiber content is equal to or greater than 50% by weight, and the second fiber content ranges from 0% to less than 10% by weight.

In another embodiment, printing and depositing the polymer resin formulation may include printing and depositing a plurality of layers of the polymer resin formulation and allowing one or more of the plurality of layers to crystallize after a layer on top has been deposited. In additional embodiments, printing and depositing the polymer resin formulation may include printing and depositing a plurality of layers of the polymer resin formulation in a manner that crystallization is delayed such that a printed layer does not crystallize until a layer just above the printer layer is fully deposited to promote intralayer bonding.

In several embodiments, the method may include tuning a ratio of semicrystalline polymer material to the amorphous polymer material to allow for sufficient layer-to-layer bonding based on a known layer or recoat time of one or more layers within the article to be printed. In yet another embodiment, the method may include using more than one blend ratio to form the article to allow for the sufficient layer-to-layer bonding for different layer times within the one or more layers within the article to be printed.

In yet another aspect, the present disclosure is directed to a method of manufacturing a rotor blade component of a wind turbine. The method includes blending a semicrystalline polymer material having a first fiber content with an amorphous polymer material having a second fiber content to form a polymer resin formulation, the first fiber content being greater than or equal to the second fiber content, the polymer resin formulation having a blended fiber content of greater than 10% by weight, the polymer resin formulation crystallizing slower than the semicrystalline thermoplastic material and printing and depositing, via a computer numeric control (CNC) device, the polymer resin formulation layer by layer to form the rotor blade component.

In an embodiment, printing and depositing the polymer resin formulation layer by layer to form the rotor blade component may include printing and depositing the polymer resin formulation layer by layer onto at least one skin layer to build up a grid structure, thereby forming the rotor blade component. In further embodiments, the rotor blade component comprises at least one of a rotor blade shell, a spar cap, a shear web, a blade tip, or a blade root. It should be understood that the method may further include any of the additional steps and/or features described herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine according to the present disclosure;

FIG. 2 illustrates a perspective view of one embodiment of a rotor blade of a wind turbine according to the present disclosure;

FIG. 3 illustrates an exploded view of the modular rotor blade of FIG. 2;

FIG. 4 illustrates a cross-sectional view of one embodiment of a leading edge segment of a modular rotor blade according to the present disclosure;

FIG. 5 illustrates a cross-sectional view of one embodiment of a trailing edge segment of a modular rotor blade according to the present disclosure;

FIG. 6 illustrates a cross-sectional view of the modular rotor blade of FIG. 2 according to the present disclosure;

FIG. 7 illustrates a cross-sectional view of the modular rotor blade of FIG. 2 according to the present disclosure;

FIG. 8 illustrates a flow diagram of one embodiment of a method of forming an article according to the present disclosure;

FIG. 9 illustrates a perspective view of one embodiment of a system for forming an article, such as a wind turbine component, via additive manufacturing according to the present disclosure; and

FIG. 10 illustrates a flow diagram of another embodiment of a method of forming an article according to the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to improved polymer-based resin formulation or blend with a certain fiber content for automated deposition of materials via technologies such as 3-D Printing, additive manufacturing, automated fiber deposition, as well as other techniques that utilize CNC control and multiple degrees of freedom to deposit material. More specifically, in certain embodiments, the improved polymer blends of the present disclosure may include semicrystalline thermoplastic resins with amorphous thermoplastic resins. More particularly, the polymer blends of the present disclosure may include crystalline polyester with amorphous polyester. In even further embodiments, the polymer blends of the present disclosure may include PBT with PETG or PC. Still another embodiment may include semicrystalline thermoplastic resin with slow crystallizing thermoplastic. For example, such an embodiment may include PBT with APET or RPET. More specifically, in certain embodiments, the polymer resin formulation may include PBT with APET that is a PET/PEI blend. Such blends may also optionally include high fiber content (e.g., greater than 10 weight %) by blending crystalline polyester with high glass fiber with amorphous polyester with minimal or no glass fibers while keeping the blend amorphous.

In one embodiment, the polymer resin formulation, as an example, may include blending semicrystalline thermoplastics with amorphous thermoplastic resins. Further, in an embodiment, blend ratios can be tailored to reduce or eliminate the crystalline behavior of the blend. Moreover, in another embodiments, the ratio of semicrystalline thermoplastic to amorphous thermoplastic can be tuned to allow for sufficient layer-to-layer bonding (e.g., thermoplastic welding) based on the known layer or recoat time of a given part design. Accordingly, the polymer resin formulations described herein may be particularly suited for 3-D printing grid structures or the like to skins or infused components so as to form a composite structure. For example, the blend ratio may incorporate more amorphous resin and less semicrystalline resin for a part design or tool-path printing strategy that results in a longer recoat time or vice versa. Moreover, the ratio of semicrystalline thermoplastics to amorphous thermoplastics can be tuned to allow for sufficient layer to layer bonding based on the thermal environment that the part may be printed in. For example, the blend ratio may incorporate more amorphous and less semicrystalline resin for a print environment that does not use a controlled heating environment that warms the environment greater than room temperature. In another embodiment, the polymer resin formulations described herein may also include one or more coupling agents based on the selected thermoplastic or thermoplastic blends.

From a fatigue resistance point of view (and typically stiffness (modulus) too), an all semicrystalline material is generally superior in performance. However, all semicrystalline materials are very difficult to 3D print (because layer-to-layer bonding is difficult due to the fast solidification/crystallization of the material) and shrinkage also can cause printing issues due to warpage. Thus, in an embodiment, an amount of APET can be added to the semicrystalline material. Upon printing, the APET slows the crystallization down to allow the initial deposition to behave more like an amorphous material. Slowing the crystallization down allows for interlayer diffusion to occur at the layer-to-layer interface of the printed part and allow for better intralayer bonding. The APET will eventually crystallize though due to the relative slow cooling of the 3D printed part (a rapid quench cooled part would cause the polymer to freeze in its amorphous state but this would require additional cooling apparatus such as a forced chilled air blower). The advantage of the slow cool is a fully semicrystalline part with superior fatigue properties. Thus, the present disclosure provides a manner to print a semicrystalline material, in an open printer without a controlled heating environment successfully, thereby resulting in superior mechanical properties (fatigue resistance and stiffness) compared to other approaches at the same amount of glass reinforcement.

Thus, the methods described herein provide many advantages not present in the prior art. For example, the polymer resin formulations of the present disclosure may include amorphous polyester blends with high fiber content, such as glass fibers, that provide several advantages for additive manufacturing of polymer articles. Such advantages include, for example, high modulus and stiffness, strong bond between print layers, as well as print layer with substrate, wide process window. High fiber content in the amorphous polyester blend also provides an added benefit of high stiffness and modulus. Moreover, the polymer resin formulations of the present disclosure have improved wettability, thereby creating more bonding sites (i.e., an important feature of interlayer bonding of 3-D printed parts).

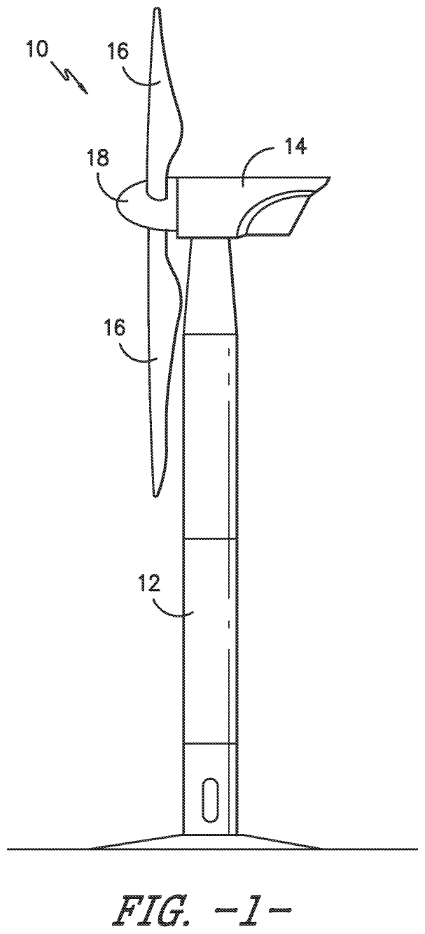

Referring now to the drawings, FIG. 1 illustrates one embodiment of a wind turbine 10 according to the present disclosure. As shown, the wind turbine 10 includes a tower 12 with a nacelle 14 mounted thereon. A plurality of rotor blades 16 are mounted to a rotor hub 18, which is in turn connected to a main flange that turns a main rotor shaft. The wind turbine power generation and control components are housed within the nacelle 14. The view of FIG. 1 is provided for illustrative purposes only to place the present invention in an exemplary field of use. It should be appreciated that the invention is not limited to any particular type of wind turbine configuration. In addition, the present invention is not limited to use with wind turbines, but may be utilized in any application using resin materials. Further, the methods described herein may also apply to manufacturing any similar structure that benefits from the resin formulations described herein.

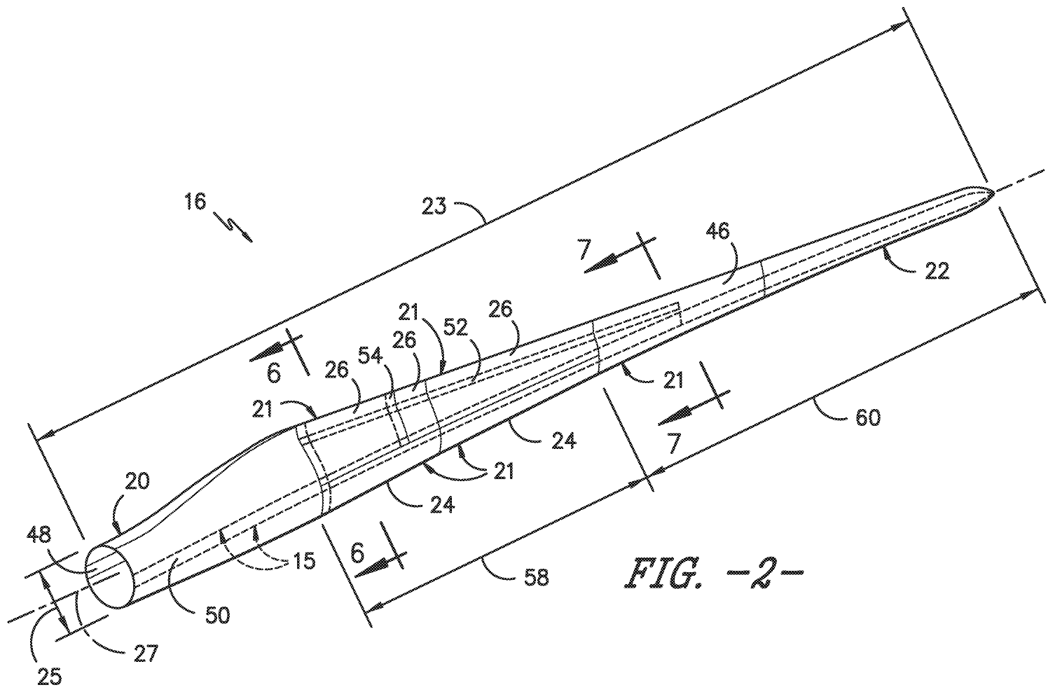

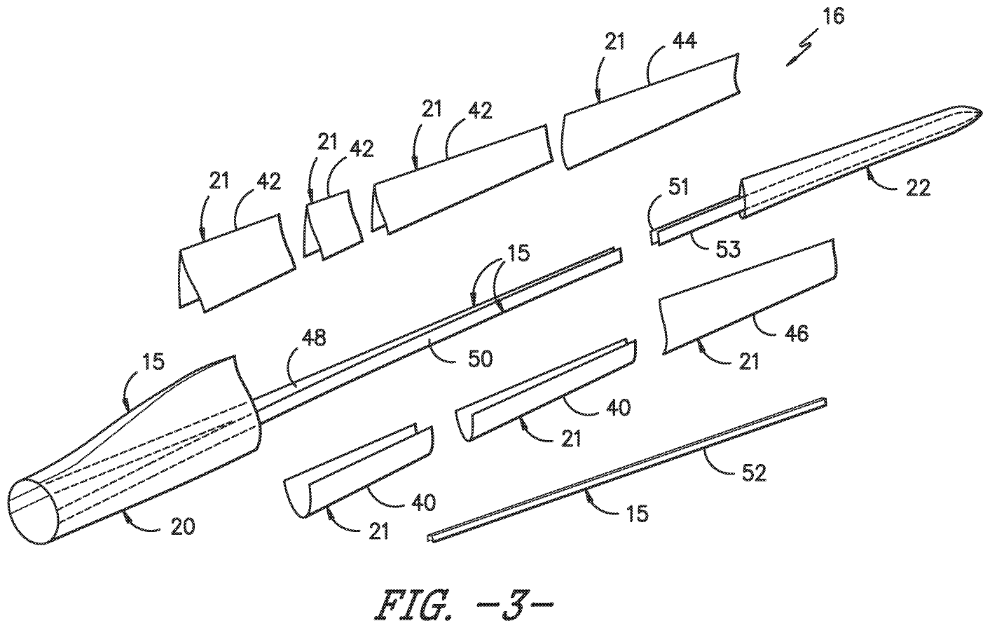

Referring now to FIGS. 2 and 3, various views of a rotor blade 16 according to the present disclosure are illustrated. As shown, the illustrated rotor blade 16 has a segmented or modular configuration. It should also be understood that the rotor blade 16 may include any other suitable configuration now known or later developed in the art. As shown, the modular rotor blade 16 includes a main blade structure 15 and at least one blade segment 21 secured to the main blade structure 15. More specifically, as shown, the rotor blade 16 includes a plurality of blade segments 21.

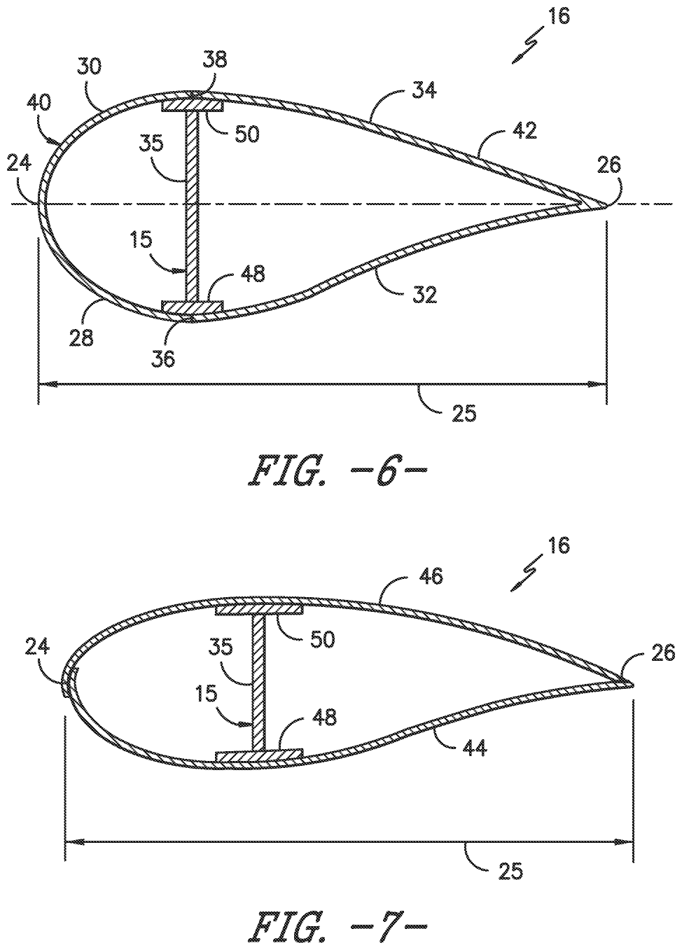

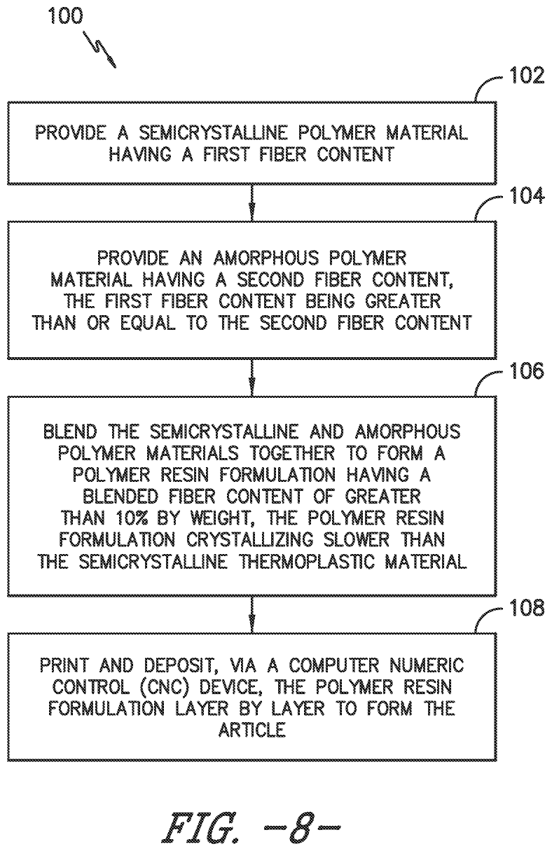

More specifically, as shown, the main blade structure 15 may include any one of or a combination of the following: a pre-formed blade root section 20, a pre-formed blade tip section 22, one or more one or more continuous spar caps 48, 50, 51, 53, one or more shear webs 35 (FIGS. 6-7), an additional structural component 52 secured to the blade root section 20, and/or any other suitable structural component of the rotor blade 16. Further, the blade root section 20 is configured to be mounted or otherwise secured to the rotor 18 (FIG. 1). In addition, as shown in FIG. 2, the rotor blade 16 defines a span 23 that is equal to the total length between the blade root section 20 and the blade tip section 22. As shown in FIGS. 2 and 6, the rotor blade 16 also defines a chord 25 that is equal to the total length between a leading edge 24 of the rotor blade 16 and a trailing edge 26 of the rotor blade 16. As is generally understood, the chord 25 may generally vary in length with respect to the span 23 as the rotor blade 16 extends from the blade root section 20 to the blade tip section 22.

Referring particularly to FIGS. 2-4, any number of blade segments 21 or panels (also referred to herein as blade shells) having any suitable size and/or shape may be generally arranged between the blade root section 20 and the blade tip section 22 along a longitudinal axis 27 in a generally span-wise direction. Thus, the blade segments 21 generally serve as the outer casing/covering of the rotor blade 16 and may define a substantially aerodynamic profile, such as by defining a symmetrical or cambered airfoil-shaped cross-section.

In additional embodiments, it should be understood that the blade segment portion of the blade 16 may include any combination of the segments described herein and are not limited to the embodiment as depicted. More specifically, in certain embodiments, the blade segments 21 may include any one of or combination of the following: pressure and/or suction side segments 44, 46, (FIGS. 2 and 3), leading and/or trailing edge segments 40, 42 (FIGS. 2-6), a non-jointed segment, a single-jointed segment, a multi jointed blade segment, a J-shaped blade segment, or similar.

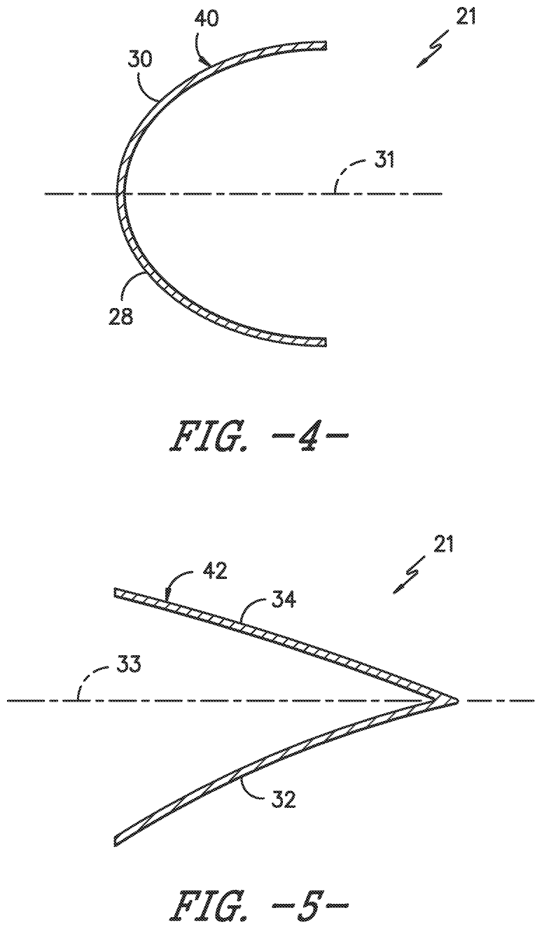

More specifically, as shown in FIG. 4, the leading edge segments 40 may have a forward pressure side surface 28 and a forward suction side surface 30. Similarly, as shown in FIG. 5, each of the trailing edge segments 42 may have an aft pressure side surface 32 and an aft suction side surface 34. Thus, the forward pressure side surface 28 of the leading edge segment 40 and the aft pressure side surface 32 of the trailing edge segment 42 generally define a pressure side surface of the rotor blade 16. Similarly, the forward suction side surface 30 of the leading edge segment 40 and the aft suction side surface 34 of the trailing edge segment 42 generally define a suction side surface of the rotor blade 16. In addition, as particularly shown in FIG. 6, the leading edge segment(s) 40 and the trailing edge segment(s) 42 may be joined at a pressure side seam 36 and a suction side seam 38. For example, the blade segments 40, 42 may be configured to overlap at the pressure side seam 36 and/or the suction side seam 38. Further, as shown in FIG. 2, adjacent blade segments 21 may be configured to overlap at a seam 54. Alternatively, in certain embodiments, the various segments of the rotor blade 16 may be secured together via an adhesive (or mechanical fasteners) configured between the overlapping leading and trailing edge segments 40, 42 and/or the overlapping adjacent leading or trailing edge segments 40, 42.

In specific embodiments, as shown in FIGS. 2-3 and 6-7, the blade root section 20 may include one or more longitudinally extending spar caps 48, 50 infused therewith. For example, the blade root section 20 may be configured according to U.S. application Ser. No. 14/753,155 filed Jun. 29, 2015 entitled “Blade Root Section for a Modular Rotor Blade and Method of Manufacturing Same” which is incorporated herein by reference in its entirety.

Similarly, the blade tip section 22 may include one or more longitudinally extending spar caps 51, 53 infused therewith. More specifically, as shown, the spar caps 48, 50, 51, 53 may be configured to be engaged against opposing inner surfaces of the blade segments 21 of the rotor blade 16. Further, the blade root spar caps 48, 50 may be configured to align with the blade tip spar caps 51, 53. Thus, the spar caps 48, 50, 51, 53 may generally be designed to control the bending stresses and/or other loads acting on the rotor blade 16 in a generally span-wise direction (a direction parallel to the span 23 of the rotor blade 16) during operation of a wind turbine 10. In addition, the spar caps 48, 50, 51, 53 may be designed to withstand the span-wise compression occurring during operation of the wind turbine 10. Further, the spar cap(s) 48, 50, 51, 53 may be configured to extend from the blade root section 20 to the blade tip section 22 or a portion thereof. Thus, in certain embodiments, the blade root section 20 and the blade tip section 22 may be joined together via their respective spar caps 48, 50, 51, 53.

Referring to FIGS. 6-7, one or more shear webs 35 may be configured between the one or more spar caps 48, 50, 51, 53. More particularly, the shear web(s) 35 may be configured to increase the rigidity in the blade root section 20 and/or the blade tip section 22. Further, the shear web(s) 35 may be configured to close out the blade root section 20.

In addition, as shown in FIGS. 2 and 3, the additional structural component 52 may be secured to the blade root section 20 and extend in a generally span-wise direction so as to provide further support to the rotor blade 16. For example, the structural component 52 may be configured according to U.S. application Ser. No. 14/753,150 filed Jun. 29, 2015 entitled “Structural Component for a Modular Rotor Blade” which is incorporated herein by reference in its entirety. More specifically, the structural component 52 may extend any suitable distance between the blade root section 20 and the blade tip section 22. Thus, the structural component 52 is configured to provide additional structural support for the rotor blade 16 as well as an optional mounting structure for the various blade segments 21 as described herein. For example, in certain embodiments, the structural component 52 may be secured to the blade root section 20 and may extend a predetermined span-wise distance such that the leading and/or trailing edge segments 40, 42 can be mounted thereto.

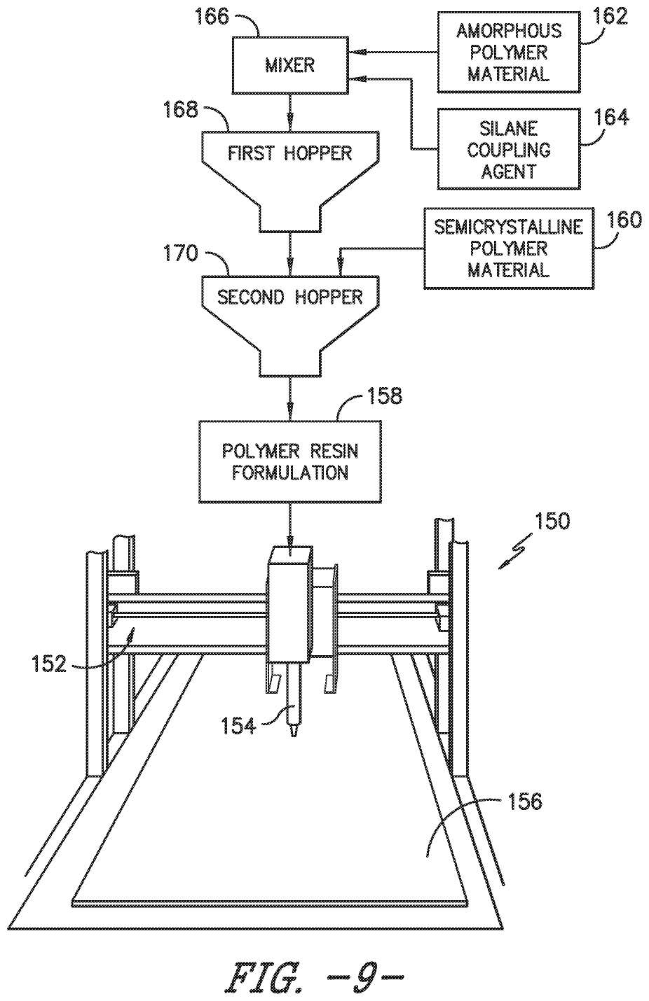

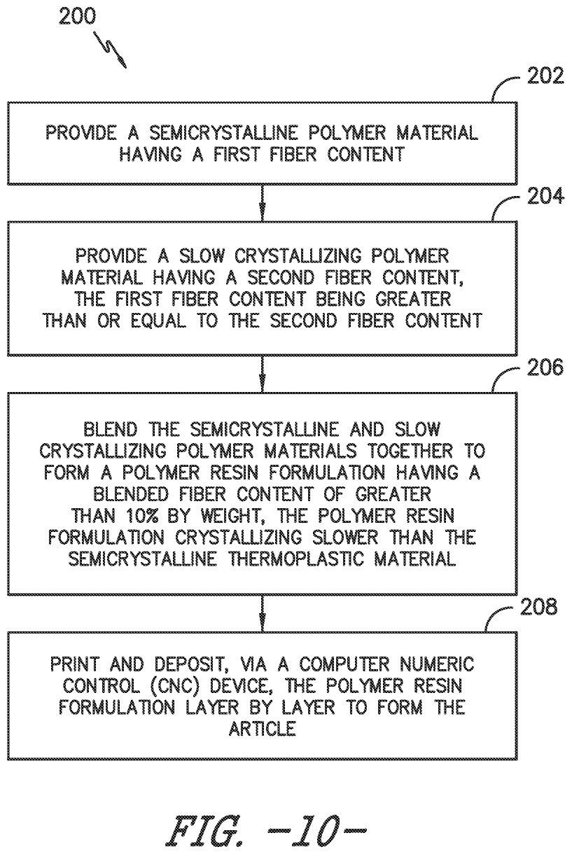

Referring now to FIGS. 8 and 9, the present disclosure is directed to systems and methods for forming polymer articles, such as any of the rotor blade components described herein. More specifically, FIG. 8 illustrates a flow diagram of one embodiment of a method 100 for forming an article according to the present disclosure. FIG. 9 illustrates a perspective view of one embodiment of a system 150 for forming an article according to the present disclosure. As such, in certain embodiments, the article may include a rotor blade shell (a pressure side shell, a suction side shell, a trailing edge segment, a leading edge segment, etc.), a spar cap, a shear web, a blade tip, a blade root, or any other rotor blade component. In general, the method 100 is described herein as implemented for manufacturing the rotor blade components described above. However, it should be appreciated that the disclosed method 100 may be used to manufacture any other rotor blade components as well as any other articles. In addition, although FIG. 8 depicts steps performed in a particular order for purposes of illustration and discussion, the methods described herein are not limited to any particular order or arrangement. One skilled in the art, using the disclosures provided herein, will appreciate that various steps of the methods can be omitted, rearranged, combined and/or adapted in various ways.

As shown at (102), the method 100 includes providing a semicrystalline polymer material 160 having a first fiber content. For example, in several embodiments, the semicrystalline polymer material 160 may be polybutylene terephthalate (PBT) or any other suitable crystalline polymer material. As used herein, a semicrystalline polymer material generally encompasses a material having ordered molecular chains (e.g., the molecular chains are largely locked in place against each other). As such, semicrystalline polymer materials are characterized as having high strength and being very rigid.

Exemplary semi-crystalline thermoplastic materials may generally include, but are not limited to polyolefins, polyamides, fluropolymer, ethyl-methyl acrylate, polyesters, polycarbonates, and/or acetals. More specifically, exemplary semi-crystalline thermoplastic materials may include poly(butylene terephthalate) (PBT), poly(ethylene terephthalate) (PET), polytrimethylene terephthalate (PTT), polypropylene, poly(phenyl sulfide), polyethylene, polyamide (nylon), polyetherketone, or any other suitable semi-crystalline thermoplastic material. In particular embodiments, for example, the semicrystalline material may be PBT with 50% glass by weight.

Referring still to FIG. 8, as shown at (104), the method 100 includes providing an amorphous polymer material 162 having a second fiber content. For example, in one embodiment, the amorphous polymer material 162 may be an amorphous polyester material, such as poly(ethylene terephthalate) glycol (PETG) or any other suitable amorphous polymer material. As used herein, an amorphous polymer material generally encompasses a material having random molecular chains that can move across each other when the polymer is pushed or pulled. In certain embodiments, the PETG may be used neat (i.e., no fiber) as part of a blend with PBT. Alternatively, the PETG may be used glass-loaded (e.g., at least about 40% fiber content, such as about 30%) as the grid material by itself. In further embodiments, other variants of PETG (such as PETC or PETT) may also be used.

Amorphous thermoplastic materials as described herein generally encompass a plastic material or polymer that is reversible in nature. For example, amorphous thermoplastic materials typically become pliable or moldable when heated to a certain temperature and returns to a more rigid state upon cooling. Some example amorphous thermoplastic materials may generally include, but are not limited to, styrenes, vinyls, cellulosics, polyesters, acrylics, polysulfones, and/or imides. More specifically, exemplary amorphous thermoplastic materials may include polystyrene, acrylonitrile butadiene styrene (ABS), poly(methyl methacrylate) (PMMA), PETG, polycarbonate, poly(vinyl acetate), amorphous polyamide, poly(vinyl chloride) (PVC), poly(vinylidene chloride), polyurethane, or any other suitable amorphous thermoplastic material. Such infusible thermoplastics can also be cast, compounded, extruded, or pultruded and may include reinforcing fibers to create pellets suitable for molding or 3-D printing processes or used in blended combination with any other suitable thermoplastic.

In addition, certain thermoplastic resins provided herein, such as PMMA and polyamides, for example, can be impregnated into structural fabrics via infusion via VARTM or other suitable infusion methods known in the art. One example of an infusible PMMA based resin system may be Elium® from Arkema Corporation. In such embodiments, infusible thermoplastics can be infused into fabrics/fiber materials as a low viscosity mixture of resin(s) and catalyst.

In addition, in an embodiment, the first fiber content of the semicrystalline polymer material 160 may be equal to or greater than 50% by weight. Further, in an embodiment, the second fiber content may range from 0% to less than 10% by weight. In particular embodiments, the second fiber content may be equal to zero. Thus, the first fiber content may be greater than or equal to the second fiber content.

Referring still to FIG. 8, as shown at (106), the method 100 includes blending the semicrystalline and amorphous polymer materials 160, 162 together to form the polymer resin formulation 158 having a blended fiber content of greater than 10% by weight. Further, the final blended polymer resin formulation 158 may crystallize slower than the semicrystalline thermoplastic material 160. In particular embodiments, for example, the amorphous material (such as PETG or APET) may be blended with the semicrystalline material by placing discrete pellets of each material in the desired ratios by weight into the same hopper. The extruder then blends the materials together for printing. As used herein, APET may generally refer to a combination of PET/PEI, which is a slow crystallizing PET that may be used without glass loading and blended with PBT.

Furthermore, in an embodiment, the polymer resin formulation may include PETG with about 40% high modulus E-glass and/or a small amount of PBT resin. In one embodiment, the PBT resin may be present in an amount preferably less than about 30% of the total resin content, e.g., to avoid causing crystallization that would reduce the process window. In another embodiment, the polymer resin formulation may include a combination of a semicrystalline thermoplastic and another semicrystalline thermoplastic with a very slow crystallization rate. In such embodiments, the slow crystallizing thermoplastic in the blend slows the overall crystallization behavior of the blend to allow for improved thermal welding, (entanglement or reptation of polymer chains across a layer boundary) compared to thermal welding without the use of a slow crystallizing semicrystalline thermoplastic.

For example, in one embodiment, a blend of PBT (a semicrystalline thermoplastic) and APET (amorphous PET) or RPET (recycled PET) may be used. APET and RPET are semicrystalline thermoplastics with a slower crystallization rate. Thus, for many industrial uses, APET and RPET are molded and cooled quickly to lock in the amorphous polymer structure that occurs in the molten state. While APET and RPET are known to be 3-D printed alone and do crystallize after 3D printing, they result in a very brittle structure unsuitable for many applications. However, by blending with another compatible thermoplastic, such as PBT and more particularly fiber reinforced PBT, the process window for 3-D printing is increased versus PBT or PBT glass reinforced alone. Thus, in such embodiments, the physical properties of the polymer resin formulation describe herein are improved as compared to APET or RPET alone.

In further embodiments, the color change that can occur with crystallization can also be used to tune the formulation percentages to deliver an appropriate delay to the onset on crystallization. Moreover, in an embodiment, this color change can be used for quality control of a printing process to ensure that previously printed material has not gone through a color change prior to the next layer deposition is complete. Further, there would be a desired delay in the color change associated with crystallization of the previously printed material before the next layer is printed. Preferably, crystallization occurs substantially after the next layer is deposited. Thus, in an embodiment, the APET or RPET used may be a modified PET/PEI polymer to further slow the rate of crystallization.

In another embodiment, the polymer resin formulation can be selected and/or tuned for thermal welding compatibility to a skin interface, such as a skin of a rotor blade of a wind turbine or any other suitable composite structure. For example, a PBT/APET blend may be selected in combination with a thermoplastic polyester film for the skin interface, such as PETG. In another example, a PBT/polycarbonate blend may be selected in combination with a polycarbonate film. In another embodiment the resin blend can be selected and/or tuned for welding compatibility to the skin interface and with respect to the temperature of the printing environment. In yet another embodiment, a PBT/APET blend with a greater concentration of PEI in the APET may be selected with a thermoplastic PETG film when used in a printing environment that is not temperature controlled with an enclosure or previously printed material reheated just prior to deposition.

In addition, in an embodiment, as shown in FIG. 9, the method 100 may also include blending a silane coupling agent 164 with the amorphous polymer material 162 via at least one of dry blending or compounding into the polymer blend. For example, as shown in the illustrated embodiment, the silane coupling agent 164 and the amorphous polymer material 162 may be dry blended via an electric mixer 166. Alternatively, the silane coupling agent 164 and the amorphous polymer material 162 may be compounded together.

As used herein, silane coupling agents generally encompass compounds whose molecules contain functional groups that bond with both organic and inorganic materials. Thus, the silane coupling agents described herein are configured to improve the mechanical strength and adhesion of composite materials and can be used for resin and surface modification.

Silane coupling agents can be polar or non-polar. For example, in an embodiment, the silane coupling agent 164 may have polar functionality. In other words, the silane coupling agent 164 may include a polar head group (e.g., a hydrophilic region). As such, the surface functionalization provided by the silane coupling agent 164 creates a larger printing window time by reducing the drying rate of the amorphous polymer material 162.

The modification of the hydrophobicity to hydrophilicity of the amorphous polymer material 162 (in addition to newly incorporated chemical groups at molecular chains of the amorphous polymer material 162 which induced this mechanical and molecular changes to the surface of the amorphous polymer material 162) can result in improved performances in the Z-direction during the printing techniques described herein.

Thus, as further shown, in an embodiment, the method 100 may include providing the blended mixture of the silane coupling agent 164 and the amorphous polymer material 162 to a first hopper 168, which can be coupled to an extruder 154 of a computer numeric control (CNC) device 152 as further described herein. As such, in certain embodiments, the method 100 may further include adding the semicrystalline polymer material 160 to the mixture of the silane coupling agent 164 and the amorphous polymer material 162, e.g., through a second hopper 170.

In another embodiment, the method 100 may include blending the mixture of the silane coupling agent 164 and the amorphous polymer material 162 with the semicrystalline polymer material 160 immediately before printing and depositing the polymer resin formulation layer by layer to form the article.

In addition, in one embodiment, the method 100 may include blending the semicrystalline polymer material 160 and the amorphous polymer material 162 at a compounder that forms a single pellet with the final blend composition. In such embodiments, the method 100 may include two heating cycles and two cooling cycles. Alternatively, the method 100 may include blending the semicrystalline polymer material 160 and the amorphous polymer material 162 as dry blend pellets, in which case the extruder on the printer blends the polymer resin formulation as the formulation is printing. In such embodiments, the method 100 may further include one heating cycle and one cooling cycle.

Thus, the inventors of the present disclosure discovered that when the addition of amorphous polymer material 162 to the polymer resin formulation 158 is more than 50% by weight (such as 75% by weight), no obvious crystallization was observed under cooling at 10° C. per minute. In addition, the crystallinity in the crystalline region of the polymer resin formulation 158 having at least 50% by weight of the amorphous polymer material 162 was about 4% at room temperature (as compared to at least 40% of solid semicrystalline polymer material 160).

Thus, as further described herein, the amorphous polymer resin formulation 158 having the increased fiber content (over plain amorphous materials) may be beneficial in 3-D printing of structural polymer parts with strong mechanical performance and robustness. This blending approach offers great technical flexibility to adjust compositions for print materials and substrate material to achieve maximum adhesion between print layers as well as print layer and substrates. It is also cost effective to achieve mechanical performance with existing commonly available resins.

More specifically, in an embodiment, a weight percent of the amorphous polymer material 162 may be greater than 50%. For example, in one embodiment, a weight ratio of the semicrystalline polymer material 160 to the amorphous polymer material 162 is 25:75. In another embodiment, a weight ratio of the semicrystalline polymer material 160 to the amorphous polymer material 162 is 30:70. In further embodiments, a weight ratio of the semicrystalline polymer material 160 to the amorphous polymer material 162 is 20:80. In yet another embodiment, a weight ratio of the semicrystalline polymer material 160 to the amorphous polymer material 162 is 10:90.

Still further embodiments of the polymer resin formulation 158 described herein may include 60 to 80% PBT pellets with 50% glass fiber by weight blended with about 20% to about 40% neat PETG. Accordingly, in an embodiment, the polymer resin formulation 158 of the present disclosure generally includes a combination of PBT pellets with glass fiber material plus amorphous poly(ethylene terephthalate) (APET) or RPET (recycled PET) blends and even more so, using slow crystallizing forms of APET that incorporate PEI into the PET. In such embodiments, the amorphous behavior of the APET during the printing process is leveraged with the reaping the benefit of higher modulus and other property benefits after crystallization.

All materials of the polymer resin formulation 158 described herein can be affected by recoat time/layer time and/or thermal conditions affecting the temperature of the previously printed layer that is being printed on. For example, in certain embodiments, an apparatus for 3-D printing unique grid structures having unique grid designs and printing techniques to shorten the recoat time/layer time to allow for less cooling and therefore better layer bonding may use the polymer resin formulation 158 described herein. In other words, the present disclosure includes tuning the grid formulation materials to the process and grid design.

Moreover, it should be understood that the polymer resin formulation 158 described herein can be printable/weldable/bondable to an outer skin material (e.g., which, as an example, may be a PETG film or a PETG-based skin). For example, the polymer resin formulation 158 described herein may be particularly suited for printing grid structures directly onto outer skins (e.g., of rotor blades or any suitable component structure) or separate therefrom and later bonded thereto. Accordingly, the present disclosure provides a system, process and related materials for forming an article that includes infusing a thermoplastic film (having a glass transition temperature Tg of greater than about 70° C. and good creep resistance) and bonding a grid structure thereto that has sufficient mechanical properties. Moreover, the materials used in forming the article can also be recycled into useful products.

In particular embodiments, the outer skin(s) described herein may be constructed to Elium® resin with a resin-rich Elium® surface or with PMMA film and may further include a printed grid structure secured thereto that is constructed of recycled Elium® skins at an appropriate glass loading (e.g., from about 30% to about 45% by weight). Still another embodiment may include an Elium®-based skin with a polycarbonate film, that includes a printed polycarbonate (PC) glass fiber grid structure. In such embodiments, the PC grid structure can also be blended with other thermoplastics to further improve properties and some may be semicrystalline (such as PBT). In further embodiments, the amount of glass in the grid structure can also be selected to improve fatigue performance. In an embodiment, for example, by reducing the amount of glass, the fatigue performance may be improved.

In particular, in an embodiment, Elium® may be used in combination with PETG and/or the other thermoplastic polyesters (such as PET, PBT etc.). In such embodiments, these combinations can be customized and/or improved upon to prevent Elium® from attacking certain films that form part of the finished structure. Further, the monomers in certain infusible resin systems can behave as a solvent to swell and dissolve other materials, including many thermoplastics. Though some amount of swell can be beneficial to promoting a good chemical bond between the infused thermoplastic and another material (including a thermoplastic film), too much swell or solvation can alter the structure of the interface layer for use in its intended purpose in successive steps. Accordingly, the infusible thermoplastic resin and the materials used to form the films can be selected such that the materials are compatible with each other (i.e., the infusible thermoplastic resin does not attack the film(s) during the infusion or curing process).

In further embodiments, the materials of the polymer resin formulation 158 may selected such that the materials can be recycled. In such embodiments, extra polymer resin formulation, as well as process scrap, can be recycled by grinding materials and re-compounding the ground material into pellets that can be molded into new parts. For example, in one embodiment, the recycled pellets may be used in subsequent grid printing, injection molding, or extruded into other parts for use in other applications.

During 3-D printing, the layer time or recoat time can have a significant effect on the layer to layer adhesion strength. As used herein, the layer or recoat time generally refers to the elapsed time from when material is deposited in one position to when new material is deposited on top of the previously-printed material in another layer. For example, in an embodiment, a factor that impacts the recoat time may include the temperature of the previously-printed material at the time when fresh material is deposited thereon. While the temperature of the freshly-deposited material is at the extrusion temperature, the layer deposited on is at a reduced temperature based on many factors including, for example, the length of time since deposited, ambient conditions surrounding the printed material, temperature of the mold, temperature of the top surface of the skin in the mold, and height of the printed grid (i.e., the distance away from the top surface of the skin). This reduction in temperature affects the rate of diffusion between layers and thus can have an effect on the interlayer strength of a printed part, such as a printed grid structure, as well as the printed grid connections at intersections or nodes. Further, as taught therein, the present disclosure encompasses material selections for the printed grid structures that can improve the final properties of the structure.

In general, amorphous resin grades are commonly preferred in printing techniques involving thermoplastic extrusion methods as the processing window for such resins is typically much greater as the material only needs to be hotter than its glass transition temperature to allow for sufficient flow. In contrast, in a semicrystalline material, the material must typically be extruded hotter than its melting point. Therefore, in semicrystalline thermoplastics, the difference in temperature between a unflowable solid state and a flowable liquid state is relatively small, whereas in a typical amorphous thermoplastic, the temperature difference between an unflowable solid and a flowable liquid is larger. In a similar way, the diffusion (also referred to as reptation) of the polymer chains in the previously-printed layer is reduced based upon its reduced temperature from its first extruded state. Semicrystalline thermoplastics upon crystallization after cooling below its melting temperature become more difficult to diffuse as the polymer chains lock up in their crystal structure. Since crystallization does not occur in amorphous thermoplastics, the ability to diffuse degrades more slowly from its extrusion temperature to its glass transition temperature. One typical example is that Nylon 11 and 12 (polyamide) are amorphous thermoplastics and are used in the industry for extrusion based 3-D printing. Still other nylons (such as polyamides) that are semicrystalline in nature such as nylon 6 and nylon 66 are known to be more challenging to print successfully.

Accordingly, the present disclosure encompasses techniques to print certain semicrystalline thermoplastics without having to resort to some of the printing conditions often required for successful printing, such as a heated enclosure or heated process envelope for the environment surrounding the printed grid or remelting previously printed grid just prior to new deposition. For example, in an embodiment, the polymer resin formulation 158 described herein may include a family of thermoplastic polyester resins, that includes, for example, PETG. This amorphous thermoplastic is easy to print with a wide processing window and results in strong printed parts. When additional stiffness is desired, short fiber reinforcement can be added which can increase stiffness up to a certain level. As fiber loading levels are increased, stiffness increases but can cause issues with interlayer strength. As fiber loadings increase beyond a certain level, the interlayer strength penalty can become unacceptable for a given application. One reason for the loss of interlayer strength is the reduction in the amount of resin available at the layer interface for diffusion. Thus, for a given minimum interlayer strength target, the amount of fiber loading can be restricted beyond that level, which then limits the stiffness that can be attained beyond that level of fiber loading. If stiffness (i.e., tensile modulus in the print direction) at greater levels is desired without sacrificing strength or substantially changing the printing conditions or change the design to reduce the layer time (and thus reduce the cooling time of the printed layer), material changes are desirable. Accordingly, in another embodiment, PBT may be used, which is a semicrystalline thermoplastic and is commonly used in injection molding applications. PBT can also be highly efficient for high glass loading compared to many other plastics and is commercially available at glass loadings up to 55% glass by weight. However, because of its semicrystalline behavior however, it is difficult to 3-D print. Accordingly, the present disclosure may also include blending these two resins (i.e., PETG and PBT) together, either by dry blending in the hopper of the printer or by compounding the blended pellets prior to printing or any other suitable means known in the art, so as to take advantage of the improved properties over fiber reinforced PETG, while mitigating the printing process risks associated with glass reinforced PBT.

Still another embodiment may include PBT blended with APET or RPET in the polymer resin formulation 158. One example of RPET may include raw material coming from recycled plastic bottles. While APET or RPET in the form of a bottle is considered a tough material, this is because the amorphous state of the material is locked in the molding process when the bottle is molded by a fast cooling rate to prevent crystallization. In 3-D printing, however, the cooling rate is slow and results in crystallization over time. Thus, by blending APET or RPET with glass-filled PBT, the present disclosure has an advantage of the amorphous nature of the APET when first extruded. After extrusion/deposition of the blend, the APET slows down the rate of crystallization of the overall blend and allows for diffusion to the previously printed layer or top of the skin. Therefore, in such embodiments, the blend of the glass-filled PBT with the APET or RPET results in superior print direction modulus as compared to glass reinforced PETG at the same glass loading level, while also allowing for a reasonable process window to achieve acceptable layer adhesion strength that could not be done with glass-filled PBT alone.

In additional embodiments, the polymer resin formulation 158 may include a slow crystallizing grade of APET, which can further widen the process window by slowing the rate of crystallization of the PBT glass fiber/APET blend. In particular embodiments, the polymer resin formulation 158 may include a polyethylene isophthalate (PEI) component added to the APET. Still further combinations may also be utilized and the aforementioned examples are not meant to be limiting, but rather, are provided for example purposes only.

In further embodiments, the polymer resin formulation 158 may include blend ratios of PBT with 50% glass pellets (up to about 60% to about 80%) with the remainder being neat APET, RPET, PET/PEI, or PETG, as well as other copolymers like poly(1,4-cyclohexylenedimethylene 1,4-cyclohexanedicarboxylate) (PCCD). Moreover, it should be understood that the resin formulation described herein can be selected based on desired printing techniques and grid designs of composite structures that can be used to form rotor blade components, e.g., a higher property, more crystalline behavior material system may be matched with a grid design that results in a short layer time or recoat time.

From a glass loading perspective, in an embodiment, the final amount in the grid structure may range between about 20 to about 45%, or from about 10% to about 60% by weight. In particular embodiments, to obtain a grid structure having 30% glass loading with PBT GF50 and APET blend, the polymer resin formulation 158 may include about 60% of the PBT GF50 pellets to 40% of the APET pellets by weight, for example. In certain embodiments, the amount of glass in the grid structure can be selected to improve fatigue performance. In an embodiment, for example, by reducing the amount of glass, the fatigue performance may be improved.

Referring back to FIG. 8, as shown at (108), the method 100 also includes printing and depositing, via the CNC device 152, the polymer resin formulation 158 layer by layer to form the article. In other words, the polymer resin formulation 158 can be used to 3-D print the article/rotor blade components described herein as well as any suitable composite component. 3-D printing, as used herein, is generally understood to encompass processes used to synthesize three-dimensional objects in which successive layers of material are formed under computer control to create the objects. As such, objects of almost any size and/or shape can be produced from digital model data. It should further be understood that the methods of the present disclosure are not limited to 3-D printing, but rather, may also encompass more than three degrees of freedom such that the printing techniques are not limited to printing stacked two-dimensional layers, but are also capable of printing curved shapes.

For example, as shown in FIG. 9, a perspective view of one embodiment the system 150 including the CNC device 152 according to the present disclosure is illustrated. More specifically, as shown, the CNC device 152 may include one or more extruders 154 that can be designed having any suitable thickness or width so as to disperse a desired amount of the polymer resin formulation 158 layer by layer to create the articles described herein with varying sizes, heights, and/or thicknesses. Further, as shown, the CNC device 152 typically includes a bed 156 or support surface where the desired article can be printed. In certain embodiments, the bed 156 may be curved and/or may correspond to the outer skins of a rotor blade. Thus, as shown, in an embodiment, the second hopper 170 may be positioned so as to directly provide the blended polymer resin formulation 158 to the extruder 154 of the CNC device 152.

Referring now to FIG. 10, a flow diagram of another embodiment of a method 200 for forming an article according to the present disclosure is illustrated. As mentioned, the article may include a rotor blade shell (a pressure side shell, a suction side shell, a trailing edge segment, a leading edge segment, etc.), a spar cap, a shear web, a blade tip, a blade root, or any other rotor blade component. In general, the method 200 is described herein as implemented for manufacturing the rotor blade components described above. However, it should be appreciated that the disclosed method 200 may be used to manufacture any other rotor blade components as well as any other articles. In addition, although FIG. 10 depicts steps performed in a particular order for purposes of illustration and discussion, the methods described herein are not limited to any particular order or arrangement. One skilled in the art, using the disclosures provided herein, will appreciate that various steps of the methods can be omitted, rearranged, combined and/or adapted in various ways.

As shown at (202), the method 200 includes providing a semicrystalline polymer material 160 having a first fiber content. As shown at (204), the method 200 includes providing a slow crystallizing polymer material having a second fiber content. As shown at (206), the method 200 includes blending the semicrystalline and slow crystallizing polymer materials together to form the polymer resin formulation having a blended fiber content of greater than 10% by weight. As such, the polymer resin formulation results in a slower crystallizing polymer versus the semicrystalline polymer 160 as described herein. As shown at (208), the method 200 includes printing and depositing, via a CNC device, the polymer resin formulation layer by layer to form the article.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A system for forming an article, the system comprising:
a polymer resin formulation comprising:
a semicrystalline thermoplastic material having a first fiber content; and,
an amorphous thermoplastic material having a second fiber content, the first fiber content being greater than or equal to the second fiber content,
wherein the semicrystalline and amorphous polymer materials are blended together to form the polymer resin formulation having a blended fiber content of greater than 10% by weight, the polymer resin formulation crystallizing slower than the semicrystalline thermoplastic material; and,
a computer numeric control (CNC) device for printing and depositing the polymer resin formulation layer by layer to form the article.

2. The system of claim 1, wherein the amorphous polymer material comprises a mixture of an amorphous thermoplastic material and a silane coupling agent.

3. The system of claim 2, wherein the silane coupling agent comprises polar functionality.

4. The system of claim 1, wherein a weight percent of the amorphous polymer material is greater than 50% of the polymer resin formulation excluding the first and second fiber contents.

5. The system of claim 1, wherein the first fiber content is equal to or greater than 30% and the second fiber content is equal to or less than 30%.

6. The system of claim 1, wherein the second fiber content is equal to zero.

7. The system of claim 1, wherein the semicrystalline polymer material comprises at least one of polybutylene terephthalate (PBT), poly(ethylene terephthalate) (PET), polytrimethylene terephthalate (PTT), polycyclohexylendimethylene terephthalate (PCT), or polyamide (PA).

8. The system of claim 1, wherein the amorphous polymer material comprises at least one of a thermoplastic copolyester, amorphous poly(ethylene terephthalate) (APET), polymethyl methacrylate (PMMA), acrylonitrile butadiene styrene (ABS), polycarbonate (PC), thermoplastic polyurethane (TPU).

9. The system of claim 8, wherein the amorphous polymer material comprises the APET, the APET contains an amount of polyethylene isophthalate (PEI).

10. The system of claim 9, wherein the amount of PEI in the APET is between about 0.5 mol % to about 50 mol %.

11. A method of forming an article, the method comprising:
providing a semicrystalline polymer material having a first fiber content;
providing an amorphous polymer material having a second fiber content, the first fiber content being greater than or equal to the second fiber content;
blending the semicrystalline and amorphous polymer materials together to form a polymer resin formulation having a blended fiber content of greater than 10% by weight, the polymer resin formulation crystallizing slower than the semicrystalline thermoplastic material; and,
printing and depositing, via a computer numeric control (CNC) device, the polymer resin formulation layer by layer to form the article.

12. The method of claim 11, further comprising blending a silane coupling agent with the amorphous polymer material via at least one of dry blending or compounding.

13. The method of claim 12, further comprising:
providing a mixture of the silane coupling agent and the amorphous polymer material to a first hopper of an extruder of the CNC device; and,
adding the semicrystalline polymer material to the mixture of the silane coupling agent and the amorphous polymer material.

14. The method of claim 13, further comprising blending the mixture of the silane coupling agent and the amorphous polymer material with the semicrystalline polymer material immediately before printing and depositing the polymer resin formulation layer by layer to form the article.

15. The method of claim 11, further comprising:
heating the blended semicrystalline and amorphous polymer materials for a first time frame; and
cooling the blended semicrystalline and amorphous polymer materials to form the polymer resin formulation.

16. The method of claim 11, wherein a weight percent of the amorphous polymer material is greater than 50%.

17. The method of claim 11, wherein the first fiber content is equal to or greater than 50% by weight, and the second fiber content ranges from 0% to less than 10% by weight.

18. The method of claim 11, wherein the semicrystalline polymer material comprises polybutylene terephthalate (PBT), poly(ethylene terephthalate) (PET), polytrimethylene terephthalate (PTT), or polyamide (PA).

19. The method of claim 11, wherein the amorphous polymer material comprises at least one of thermoplastic copolyester, amorphous poly(ethylene terephthalate) (APET), polymethyl methacrylate (PMMA), acrylonitrile butadiene styrene (ABS), polycarbonate (PC), thermoplastic polyurethane (TPU).

20. The method of claim 11, wherein printing and depositing the polymer resin formulation further comprises:
printing and depositing a plurality of layers of the polymer resin formulation and allowing one or more of the plurality of layers to crystallize after a layer on top has been deposited.

21-26. (canceled)
